(19) United States
(12) Patent Application Publication
(10) Pub. No.: US 2008/0177021 A1
(43) Pub. Date: Jul. 24, 2008

(54) Method For Modifying a Substrate

(76) Inventors: Peter Berlin, Linnich (DE); Adrian Jung, Julich (DE); Bernd Wolters, Julich (DE)

Correspondence Address: K.F. ROSS P.C., 5683 RIVERDALE AVENUE, SUITE 203 BOX 900, BRONX, NY, 10471-0900, US

(21) Appl. No.: 11/884,861

(22) PCT Filed: Jan. 21, 2006
(86) PCT No.: PCT/DE2006/000093

§ 371 Date: Aug. 21, 2007

(30) Foreign Application Priority Data
Feb. 24, 2005 (DE) 10 2005 008 434.6

(51) Int. Cl. C08G 77/04; C08B 15/00

(52) U.S. Cl. 528/10; 536/56

(57) ABSTRACT

The invention concerns a method for modifying a substrate, including the following steps: the substrate is contacted with at least one amino-cellulose derivative and/or with at least one NH₂-(organo)polysiloxane derivative; a composite substrate material is formed from the substrate and the amino-cellulose derivative and/or the substrate and the NH₂-(organo)polysiloxane derivative. Said method enables a customized structural substrate design to be obtained. The resulting composite substrate material can be used to produce implants, detectors and scanning probe tips.

The invention relates to a method of modifying a substrate.

The nanoscale surface modification of substrate materials with multifunctional and/or biofunctional properties is an important branch of nano-technology that affects nearly all future technologies from nano-electronics with bioelectronic functional components to biosensors to biocompatible materials such as implants or carriers of active ingredients.

From Berlin et al. (Berlin P., Klemm D., Jung A., Liebegott H., Riesler R., Tiller J., Film-forming aminocellulose derivatives as enzyme-compatible support matrices for biosensor developments. Cellulose 2003, Vol. 10, pgs. 343-367) it is known to apply an aminocellulose derivative (ACD) on a glass substrate. The relatively thick ACD films measuring approximately 100 to 200 nanometers in thickness produced this way are regularly provided with covalently immobilized biomolecules to form biochip surfaces and are used for the detection of complementary structures.

From Jung et al (Jung A., Berlin P., Wolters B., Biomolecule-compatible support structures for biomolecule coupling to physical measuring principle surfaces. IEE Proceedings Nanobiotechnol. 2004, Vol. 151, No. 3, pgs. 87-94) another film-forming variant is known. Starting from an aminocellulose derivative and a gold substrate functionalized with carboxyl groups by 3-mercaptopropionic acid, the production of biochip surfaces with covalently immobilized enzyme protein is known.

This disadvantage is that film particles with covalently immobilized enzyme protein are detached again from the substrate surface upon contact of the biochip surfaces with aqueous solutions.

It is the object of the invention to provide firmly fixed multifunctional or biofunctional surface structures.

The object is achieved with a method according to the main claim and a material according to the dependent claim. Advantageous embodiments will be apparent from the respective claims referring to these two claims.

The method comprises the following inventive steps:

A substrate is brought in contact with at least one aminocellulose derivative and/or with at least one NH₂-(organo)polysiloxane derivative.

The method is characterized in that a composite substrate material forms from the substrate and aminocellulose derivative and/or substrate and NH₂-(organo)polysiloxane.

The term composite substrate material shall be considered synonymous with composite material in the present invention. The produced composite substrate material comprises firmly bonded materials, the surface properties of these materials exceeding those of the individual components.

Firmly bonded shall be understood such that the surface structures cannot be detached in solvents with a wide variety of electrolyte compositions, for example also including ultrasound treatment. Covalently immobilized biofunction molecules are also not detached from the composite substrate material.

Advantageously, the inventive method provides a plurality of novel inventive composite substrate materials as needed for varied applications.

Upon contact of the substrate with a modifying solution, the composite substrate material is formed by spontaneous, adhesive self-organization of an aminocellulose derivative or NH₂-(organo)polysiloxane derivative contained therein. During this process, mono-layers of aminocellulose polymer chains or NH₂-(organo)polysiloxanes are formed on the substrate while influencing the substrate surface structure.

The composite substrate material produced by the inventive method comprises at least two different materials, namely a substrate with aminocellulose derivative and a substrate with NH₂-(organo)polysiloxane derivative. Depending on the involved components, it has novel and advantageous properties that the individual components do not have.

It is conceivable that the composite substrate material comprises three or more materials, for example a substrate with an aminocellulose derivative and an NH₂-(organo)polysiloxane.

Upon contact of the substrate with the modifying solution, a polymer mono-layer interface structure is formed as a result of the complementary adhesive electron structures of the components and the subsequent self-organization. Due to a common electron band structure, the components enter a tight bond with one another.

Very advantageously, it is generally sufficient to bring the substrate in contact with the modifying solution by very simple means. This includes simple swiveling, dipping, short-term storage and the like. More complex method, for example spin-coating, dip-coating, air-brushing, micro-contact printing, can be used, but are not required.

Spin-coating is used, for example, at 1 to 20 thousand revolutions per minute, particularly 15 thousand revolutions per minute, and a rotation duration of 3 to 10 minutes.

In the case of dip-coating, the substrate may be immersed in the modifying solution, for example, for 5 to 60 seconds, particularly for 30 seconds.

In a further embodiment of the invention, the modifying solution may be applied on the substrate by means of a micro- or nano-structured stamp made of polymer, particularly poly(dimethylsiloxane) (PDMS), or by micro- or nano-contact printing (mCP).

Advantageously, the surface structures are stamped onto the substrate material, for example in the form of a nanoscale line pattern with application-specific line distances and line widths. For this purpose, the stamp may be wetted with the modifying solution and then brought in contact with the substrate surface for 2 to 15 minutes. The stamp may also have been saturated beforehand by shaking in the modifying solution for a period of 1 to 3 hours and after saturation it may have been exposed to an argon flow for 1 to 2 minutes.

The surface of the composite substrate material can have been functionalized or chemically activated by means of a NH₂-reactive biofunctional reagent by NH₂-reactive functionalization so as to change the water contact angle, that is to change the hydrophobicity/hydrophilicity balance, and/or for covalent coupling with (bio)function molecules or nanoparticles.

The NH₂-reactive functionalization process can advantageously be selected as a function of the specific application. This process advantageously achieves that positive or negative charge distributions, pH, chelate, redox or chromogen properties are established across the entire area or in the form of structural patterns on the surface of the composite substrate material.

For these methods., advantageously also high temperatures or other catalysts are not required, but instead spontaneous adhesion occurs even at room temperature.

Within the scope of the invention, surprisingly it was found that spontaneous adhesion on the substrate generally occurs after only a few minutes (<5 minutes). Consequently, the method typically provides for brief contact between the substrate and the modifying solution.

The method may be used for modifying the entire surface of arbitrarily small substrate dimensions or for modifying surfaces in micro-fluidic (sensor) systems or for producing microscale and nanoscale surface structure patterns, in accordance with the principle of micro-contact printing. The concentration of the employed aminocellulose derivatives and NH₂-(organo)polysiloxanes must not be selected too high. Otherwise, the aggregates of the employed polymer derivatives are deposited on the substrate surface that within the meaning of the invention are not considered composite substrate materials.

It is particularly advantageous if a 0.05 to 0.5% aminocellulose derivative solution of the formula I (see below) is used as the modifying solution. It is conceivable to use higher dosages up to 5%, however in this case the washing process must be intensified.

In a further embodiment of the invention, a 0.03 to 1% NH₂-(organo)polysiloxane solution of the general formulas P1 to P5 (see below) is used as the modifying solution. A concentration of approximately 0.03 to 0.1% is particularly advantageous.

Upon contact with the modifying solution, the substrate is washed with the respective solvent, for example by multiple shaking using solvents or in an ultrasonic bath.

When performing the substrate treatment in this way, the polymer chains on the substrate are present with thickness dimensions of <1 to 3 nanometers.

In the case of an aminocellulose derivative, this corresponds only to one mono-layer of the corresponding polymer chain applied on the substrate.

The polymer chains are firmly fixed on the substrate using common electron band structures, as mentioned above, and give the formed composite substrate material a new quality with respect to subsequent application. Within the scope of the invention it was found that, depending on the type of aminocellulose derivatives and/or NH₂-(organo)polysiloxanes used, for the first time a structured design is possible on the substrate for a further preferably biophysical or biomedical application.

A fundamental advantage when using polysaccacharide structures in the form of cellulose structures is that polysaccharides occur naturally in the company of proteins or cells and bind to the same.

In a further embodiment of the invention, the composite substrate materials are provided with function molecules that can be selected as a function of the application.

This advantageously achieves that further molecules, for example biofunction molecules, are applied on the mono-layers made of aminocellulose derivative or NH₂-(organo)polysiloxanes by electrostatic or covalent coupling. These molecules, for example, then serve the detection of an analyte with a complementary structure. It is conceivable to promote or prevent protein or cell adhesion or a defense reaction by the body by such a structural design.

The inventive composite substrate materials are used, for example, in the production of biochips and implants with improved biocompatible surface properties in the sense of improved body compatibility. It is particularly advantageous if suitable textile substrates, for example cotton, are structured with desired modifying solutions.

The method according to the invention and the composite substrate materials are particularly used for the development of nano-structured biofunctional implant surfaces.

The inventive surface structure design may be applied on all biomedically relevant substrate materials or implants for producing surface structures recognized as being biocompatible, for example hydrophobic, hydrophilic, electrostatically negative, biofunctionalized, nanoscale structural patterns or cell adhesives or topographically defined surfaces.

Properties and application possibilities of this type are only possible with the inventive composite substrate material, not however with the individual components and certainly not with non-modified substrates or implants.

The substrates forming composite substrate materials with the aminocellulose derivatives or NH₂-(organo)polysiloxane derivatives all have in common that with respect to the derivatives they have complementary adhesive electron structures, preferably by oxygen or hydroxy functions on the substrate surfaces that bring about the adhesive self-organization of the aminocellulose derivatives and/or NH₂-(organo)polysiloxanes, particularly via the NH₂ groups thereof, and thus ensure a tight bond.

It is particularly advantageous if there are no restrictions in the selection of the substrate.

For example, biophysically and medically relevant or also textile substrates may be selected, provided they are suited to form a composite substrate material having the above-mentioned properties with the aminocellulose derivatives or NH₂-(organo)polysiloxanes.

Substrates that unfold only limited to no adhesive properties upon contact with a modifying solution are treated according to a further embodiment of the invention beforehand with oxygen plasma or another method producing oxygen or OH functions.

For this purpose, it is particularly advantageous if they are coated beforehand with an ultrathin SiOₓ polymer film measuring <1 to 2 nanometers in thickness.

Within the scope of the method, it would certainly be conceivable to dispose different substrates, for example to form an array, next to one another in a plane.

Possible substrates are: Glass-type substrates (hydrophilized or pyrolytically coated with SiOₓ polymer), Si or SiO₂ substrates with native or thermally produced SiO₂ polymer layer or pyrolytically coated with SiOₓ polymer and metal and metal/metal oxide substrates. These include, for example, gold, silver, platinum, titanium, tantalum, aluminum, zirconium, vanadium, niobium, chromium, molybdenum, tungsten, manganese, technetium, rhenium, ruthenium, osmium, cobalt, rhodium, iridium, nickel, palladium, copper and the oxides thereof.

Macromolecular substrates, such as ceramics made of zirconium oxide, or nanoparticles, such as gold, SiO₂ or metal oxide nanoparticles are likewise included.

The following are also possible: Polymers with hydroxy groups or oxygen functions, for example polysaccharides (cellulose in fiber or hollow fiber form and bacteria cellulose in areal or tubular shape), polysiloxanes or (organo)polysiloxanes, for example polydimethylsiloxane (PDMS), NH₂-(organo)polysiloxanes, polymethylmethacrylate, poly-N-isopropyl acrylamide (PNiPAN), poly(glycolide-co-lactide) (PGL), polymers with carboxyl or sulfo groups (polyhydroxyethyl methacrylate (PHEM), cation-binding polystyrenes), proteins (collagens, glycoproteins) and textile substrates, for example cotton, wool.

The multifunctional surface structures of the composite substrate materials are characterized by thickness dimensions of less than 1-3 nanometers.

They have a highly variable hydrophilicity and hydrophobicity balance, characterized by a water contact angle smaller from than 40 to larger than 90 degrees.

Furthermore, they have a high structural variability of the covalent functionalization possibilities, starting from NH₂ anchor groups density of 0.2 to 5 nMol per cm² of the substrate surface.

A defined surface topography at RMS roughness values of 0.5 to 2 nanometers measured by AFM is common. Insofar as the substrate is treated with plasma, particularly with argon or oxygen plasma prior to modification, advantageously particularly low RMS roughness values of smaller than 0.5 nanometer of the composite substrate material surface are formed.

To prepare the modifying solution, the aminocellulose derivatives are preferably dissolved in bidistilled water or dimethyl acetamide (DNA).

NH₂-(organo)polysiloxanes are preferably dissolved in methanol, ethanol or 2-propanol.

They are preferably filtered by means of centrifugal filter tubes having a pore size of 0.2 to 0.45 mm.

### 1. Aminocellulose and NH₂-(Organo)Polysiloxane Derivatives

Possible aminocellulose derivatives are, for example, all compounds mentioned in formula pattern I below.

### Formula Pattern I

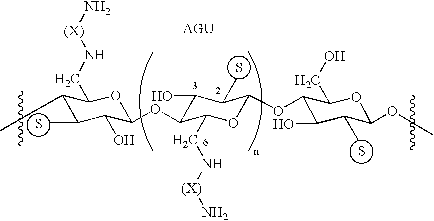

General formula I: Anhydro-glucose unit (AGU)

Possible substituents on the AGU are:

S=acetate, benzoate, carbanilate, propionate, tosylate or methoxy groups, according to the substitution degree of S (DS_{S}: 0<DS_{S}<2 on C2/C3 of the AGU).

(X)=spacer groups, according to the substitution degree of —NH(X)NH₂ (DS_{NH(X)NH2} 0<DS_{NH(X)NH2}, 1) on C6 of the AGU): See types a to d in formula pattern 1.

n=100 to 1,500, preferably 200.

Derivatives of the aminocellulose lead structure according to general formula I can be:

Type a: (X)=alkylene radical (CH₂)ᵢ; i=2, 3, 4, 5, 6, 7, 8, 9, 10, 11 or 12;

Type b: (X)=oligoamine radical, for example

—CH₂—CH₂—NH—CH₂—CH₂—, (“DETA cellulose”) or

—CH₂—CH₂—CH₂—NH—CH₂—CH₂—CH₂—, (“DPTA cellulose”) or

—CH₂—CH₂—NH—CH₂—CH₂—NH—CH₂—CH₂—, (“TETA cellulose”) or

—CH₂—CH₂—NH—CH₂—CH₂—NH—CH₂—CH₂—NH—CH₂—CH₂—, (“TEPA cellulose”) as isomers or

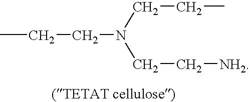

These derivatives of type b preferably have tosylate as the substituent S, wherein the derivative is water soluble, or it has carbanilate, wherein the derivative is soluble in DMA.

Type c: (X)=aryl or aryl alkylene radical, for example

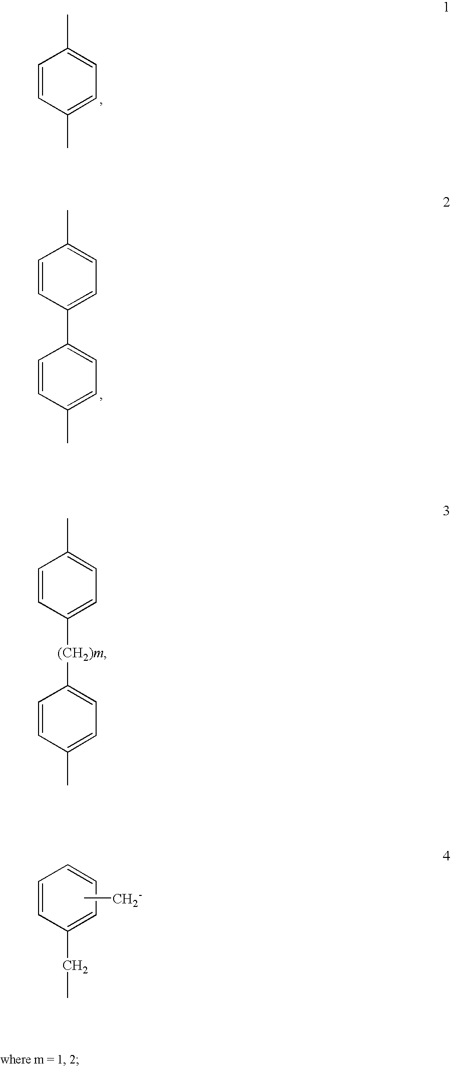

(1)=PDA cellulose tosylate or

(4a)=XDAₒ cellulose carbanilate

(4b)=XDAₘ cellulose carbanilate

(4c)=XDAₚ cellulose carbanilate

Type d: N,N-disubstituted PDA cellulose, with redox-chromogenic properties, for example:

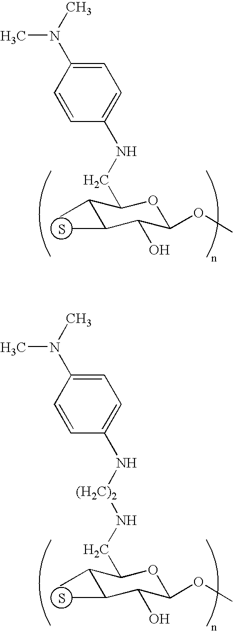

The above-mentioned derivatives according to formula pattern 1 can be expanded by further derivatizations of tosylcellulose or tosylcellulose derivatives with diamines, oligoamines or polyamines.

Possible NH₂-(organo)polysiloxane derivatives are, for example, the compounds in formula pattern 2 below:

### Formula Pattern 2

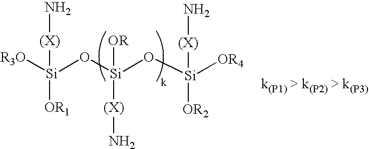

### General Formula II

The NH₂-(organo)polysiloxane derivatives P1 to P3 are produced by a mixture of NH₂-(organo)silane/water, preferably with the molar ratios of 1:3 (P1), 1:2 (P2) and 1:1 (P3).

For the radicals the following applies:

Either

R₁ and R₂═H or methyl or ethyl and

R, R₃ and R₄═NH₂-(organo)polysiloxane structures,

or

R₁ and R₃═H or methyl or ethyl and

R, R₂ and R₄═NH₂-(organo)polysiloxane structures,

or

R₁ and R₄═H or methyl or ethyl and

R, R₂ and R₃═NH₂-(organo)polysiloxane structures,

or

R₂ and R₄═H or methyl or ethyl and

R, R₁ and R₃═NH₂-(organo)polysiloxane structures,

or

R₂ and R₃═H or methyl or ethyl and

R, R₁ and R₃═NH₂-(organo)polysiloxane structures.

For the substituents (X) in P1 to P3 the following applies:

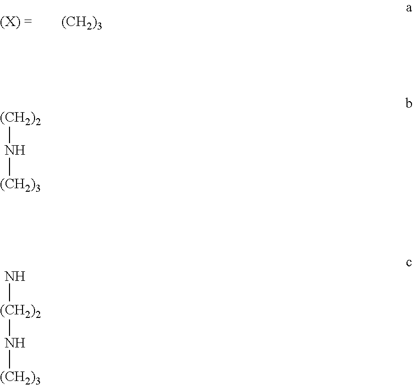

However, it is also possible to use the following compounds P4 to P5 as NH₂-(organo)polysiloxane derivatives.

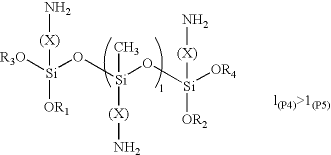

General formula II (continued)

The NH₂-(organo)polysiloxane derivatives P4 and P5 are produced by a mixture of NH₂-(organo)silane/water, preferably with the molar ratios of 1:2 (P4) and 1:1 (P5).

For the radicals the following applies:

Either

R₁ and R₂═H or methyl or ethyl and

R₃ and R₄═NH₂-(organo)polysiloxane structures,

or

R₁ and R₃═H or methyl or ethyl and

R₂ and R₄═NH₂-(organo)polysiloxane structures,

or

R₁ and R₄═H or methyl or ethyl and

R₂ and R₄═NH₂-(organo)polysiloxane structures,

or

R₂ and R₄═H or methyl or ethyl and

R₁ and R₃═NH₂-(organo)polysiloxane structures.

For the substituents (X) in P4 to P5 the following applies:

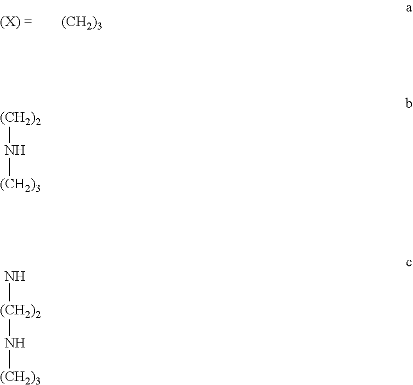

The above-mentioned NH₂-(organo)polysiloxane derivatives according to formula pattern 2 may be used particularly advantageously also in combination with the aminocellulose derivatives for the inventive structured design of the composite substrate materials.

In a further embodiment of the invention, the substrate in the case of the inventive structured design may be pyrolytically modified by a NH₂-(organo)polysiloxane derivative in advance by means of the hydrophilic SiOₓ polymer with a thickness of less than 1 to 2 nanometers.

This is advantageously possible by a simple and short, that is lasting less than 1 second, treatment of the substrate using the method according to 2.3.

The method according to the invention can also be used for such substrate materials that do not form spontaneous adhesively driven surface structures with the derivatives according to formula patterns 1 and 2.

2.1 Surface Structure Design of Substrates with Aminocellulose Derivatives

The basis of the derivatization of the aminocellulose lead structure is the different S_{N2} reactivity of the OH functions on C6 or C2/C3 of the AGU, see general formula I.

The general derivatization approach is based, for example, on a 6(2) —O-tosyl cellulose derivative, preferably on commercially available 6(2) —O-tosyl cellulose or 6(2) —O-tosyl cellulose carbanilate that on C6 of the AGU have a reactive tosylate radical and on C2/C3 of the AGU have solubility-conveying substituent groups, such as tosylate or carbanilate with different substitution levels DS (0<DS₈<2) (see “S” in the general formula I).

The tosylate radical is substituted on C6 by diamine or oligoamine compounds H₂N—(X)—NH₂” (see (X) in formula I). For this purpose, tosyl cellulose or tosyl cellulose carbanilate in dimethyl sulfoxide (DMSO) is mixed with a modifying reagent H₂N—(X)—NH₂ (see (X), types a to d in formula pattern 1) and heated to 70 to 100° C. for 3 to 6 hours. After cooling, the reaction mixture is poured into a vessel with tetrahydrofurane. During this step, the desired aminocellulose derivative is precipitated as solid matter. The derivative is isolated, washed with tetrahydrofurane and ethanol and then dried. Depending on the structure of the substituent S (see general formula I) and the degree of substitution DS_{S} on C2/C3, the aminocellulose derivative is soluble in water or dimethyl acetamide (DMA).

All derivatives of the aminocellulose according to formula pattern 1 are produced this way.

The method according to the invention is therefore particularly advantageously based on the varied structural modification possibilities of aminocellulose with general derivatization.

The variety of derivatives can advantageously be completed if the general derivatization is based on tosyl cellulose derivatives with substituent groups S, such as acetate, propionate, benzoate, methoxy on C2/C3 of the AGU, and if further diamines, oligoamines or polyamines are included in the substitution reaction on C6.

### 2.1.1 Spacer Effect and Structural Property Patterns by (X) on AGU Position C6

Spacer effects on the NH₂ terminal groups if the cellulose chain are provided on AGU position C6 in that (X) in the general formula I is an alkylene, aryl, aralkylene or oligoamine structure (see (X) types a to d in formula pattern. 1). For example, the matrix distances vary between approximately 0.4 and 2 nm if derivatives with structures (X) of the type a or b series from formula pattern 1 are used.

As a result of structures (X) of the types a to c series, particularly the reactivity or spontaneous adhesion properties along the aminocellulose polymer chains are modified, as well as the pH properties and hydrophilicity or hydrophobicity balance.

Advantageously, for example, with increasing alkylene chain length (X) according to type a from the formula pattern 1, the hydrophobic property pattern of the corresponding derivatives can be adjusted to be more dominant and the spacer effect to be greater.

Insofar as special electron transfer properties of the composite substrate material are desired, aminocellulose derivatives with EDA (type a, i=2) or with oligoamine radicals (type b) on C6 can be used, since these derivatives form chelates with heavy metal ions, for example blue Cu²⁺ chelates (l_{Max} values=560 to 630 nm) that when used provide the corresponding substrate surfaces with special electron transfer properties. For this reason, they are particularly significant for the coupling with biological redox systems, particularly with Cu proteins.

Derivatives with spacer structures (X) of types c and d are advantageously redox-active or chromogenic. In the case of adhesive fixation on substrate surfaces, these properties have special electron transfer properties as a function of the structure (X) and redox chromogenic subsequent reaction.

The degree of structural modification by means of (X) along the aminocellulose polymer chains can be changed with the substitution level DS_{NH(X)NH2}.

In the case of a lateral transmission to the substrate surface, it determines the density of the functional groups and in relation to the substitution S or DS₈ the functional property on the substrate surface.

### 2.1.2 Solubility and Hydrophilicity or Hydrophobicity Balance by Means of S on AGU Position C2/C3

The aminocellulose derivatives are also provided with advantageous properties by means of substitution of the OH groups on C2/C3 by different ester groups. This has a significant influence on the solubility of the aminocellulose derivatives. The substitution level DS₈, that is the ratio of OH/ester groups on the (aminocellulose) polymer chains determines whether the derivative is soluble in water or in an organic solvent, for example DMA. In addition, the DS₈ influences the hydrophilicity or hydrophobicity balance. Furthermore, the structures on AGU positions C2/C3 (OH or ester group) also influence the adhesive electron structure properties of the aminocellulose polymer chains.

For example, EDA cellulose tosylates (type a, i=2) or aminocellulose tosylates of the (X) type b series from formula pattern 1 are water soluble at DS_{Tosylate} values of 0.1 to 0.2. In an aqueous environment, pH values between 10 and 11 develop in these derivatives.

For the structural design, optimum biomolecule-relevant pH values, for example pH 5.5 to 8, can be adjusted by means of titration, for example with 5 n HCl.

### 2.2 Surface Structure Design of Substrates by Means of NH₂-(Organo)Polysiloxane Derivatives

The NH₂-(organo)polysiloxanes of the general formulas P1 to P5 from formula pattern 2 are formed by NH₂-(organo)alkoxysiloxane/water mixtures or NH₂-(organo)alkoxysiloxane/water/ethanol mixtures or NH₂-(organo)alkoxysiloxane/water/methanol mixtures or preferably NH₂-(organo)alkoxysiloxane/water/2-propanol mixtures. The composition can vary, for example between (organo)alkoxysilane/water mol ratios of 1:3, 1:2 or 1:1 and the addition of a catalytic amount in HCl by stirring for 3 to 4 hours.

The NH₂-(organo)polysiloxanes obtained in this way advantageously dissolve between 0.03 and 1%, for example, in methanol, ethanol or 2-propanol and are then available for the surface modification method according to the invention.

For the production of NH₂-(organo)polysiloxanes, the (organo)alkoxysilanes used are, for example, 3-aminopropyl-trimethoxysilane, 3-aminopropyl-triethoxysilane, 3-[2-(2-amino-ethylamino)ethylaminolpropyl-trimethoxysilane, 3-(2-aminoethylamino)propylmethyl-dimethoxysilane or preferably 3-(2-aminoethylamino)propyl-trimethoxysilane or silane mixtures of NH₂-(organo)alkoxysilanes or NH₂-(organo)alkoxysilanes and (organo)alkoxysilane (without NH₂ groups) or NH₂-(organo)alkoxysilanes and tetraalkoxysilane.

The NH₂-(organo)polysiloxane derivatives are preferably used in ethanol or 2-propanol solutions and are filtered, for example, by means of centrifugal filter pipes (pore size for example 0.2 to 0.45 mm) before use.

It is particularly advantageous if the relatively hydrophobic NH₂-(organo)polysiloxane derivatives are used in combination with aminocellulose derivatives.

Advantageously, for example, composite substrate materials with microscale and nanoscale patterns of alternating hydrophobic and NH₂-group containing surface structures or alternating NH₂-group containing surface structures with different NH₂ spacer lengths (X) are produced starting from NH₂-(organo)polysiloxane-modified substrate surfaces and mCP using corresponding aminocellulose derivatives.

It is also advantageous to use NH₂-(organo)polysiloxane derivatives for the hydrophobization of suitable textile substrates or for the surface structure design of aluminum oxide or zirconium oxide ceramics, or of biochips, preferably based on the glass-type, Si/SiO₂, gold, PDMS substrates, and subsequent biofunctionalization, for example in micro-fluidic sensor systems.

In the case of other combined applications of NH₂-(organo)polysiloxanes and derivatives of the aminocellulose lead structure for the production of composite substrate material, for example the process is as follows: Starting from SiOₓ-polymer modified glass-type substrates or Si/SiO₂ substrates, the substrate surface is modified by means of NH₂-(organo)polysiloxane derivative P1a according to formula pattern 2. Then, the mixture is protonated, for example with 0.1 n HCl and afterward treated, for example, with a modifying solution of EDA cellulose carbanilate (type a, i=2) according to (X) type b from formula pattern 1. It is particularly advantageous if this brings about an alignment of the aminocellulose polymer chains in more or less vertically aligned polymer chain bundles.

Also this alignment is self-adjusting, so that the aminocellulose polymer chains on the one hand repulsively align on the substrate surface and on the other hand aggregate with chain adhesion. In the AFM measurement, this is represented on the substrate surface as typical polymer chain bundles or a brush-shaped topography.

In the AFM measurement of the modified substrate surfaces, trough or concave topographies become visible.

These special topographic surface structures are particularly advantageous for biochip developments, where substrate surfaces with a high level of bio-functionalization are required. With this topography of the aminocellulose structures, numerous NH₂ anchor groups are available for the bio-functionalization along the polymer chains by means of NH(X)—NH₂ on C6 of the AGU with an ideal chain length of approximately 100 nm.

Furthermore it is advantageous that derivative-typical environment conditions develop between the polymer chains on the substrate surface. During the modification of substrate surfaces, this opens up the possibility of using aminocellulose derivatives that based on their structures ((X) and S as well as the substitution levels DS_{NH(X)NH2} and DS_{S} allow biospecific environmental conditions to be expected.

In the case of covalent bio-functionalization, also NH₂-reactive coupling reagents influence the environmental conditions on the composite substrate material surface, as corresponding studies using enzyme proteins as biofunction molecules have demonstrated.

### 2.3 Surface Modification of Substrates by Means of Hydrophilic SIOₓ Polymer

A silicoating method is surprisingly excellently suited to hydrophilize substrate materials that are stable to heat for a short time by forming an ultrathin SiOₓ polymer structure. The core of the method is a burner that is filled with a Pyrosil gas mixture. The gas mixture contains a silicon-organic compound that disintegrates by flame pyrolysis when using the method while forming an SiO₂/silicate mixture

For example, on glass-type, silicon or metal substrate surfaces an SiO₂/silicate mixture is formed by briefly fanning it with the flame of the above-mentioned burner for a short period (<1 second), whereupon after a short time a glass-like SiOₓ polymer in the form of an ultrathin and transparent surface structure with a thickness of less than 1-2 nanometers is produced. The SiOₓ polymer-modified substrate surfaces have similarly low RMS roughness values as the SiO₂ polymer layers on Si substrate samples produced thermally at 600° C.

The highly hydrophilic SiOₓ polymer (water contact angle less than 10 to 15 degrees), as mentioned above, is used beforehand if the inventive formation of the composite substrate material by means of surface modification via aminocellulose derivatives and/or NH₂-(organo)polysiloxanes does not produce the desired result from the start.

The obviously high OH group density or hydrophilicity of the SiOₓ polymer, however, can also be used directly, that is can be applied without further functionalization, for adhesive bio-functionalization processes, for example by functional proteins, cells or other bio-function molecules, or for covalent bio-functionalization processes using conventional OH-reactive reagents.

### 2.4 Variation Possibilities of the Method

The surface modification process takes place simply in a mixture of the substrate sample and a modifying solution, comprising a derivative of the aminocellulose according to formula pattern 1 in bidistilled water or dimethyl acetamide (DMA) or an NH₂-(organo)polysiloxane derivative according to formula pattern 2, for example in 2-propanol.

For example, 0.03 to 1% filtered derivative solutions are brought in contact with the substrate samples.

What method will be applied will depend substantially on the substrate material and the required quality as well as the application purpose of the modified substrates. However, also the type of pretreatment of the substrate surface, for example cleaning or a preceding plasma treatment or modification using SiOₓ polymer of the substrate, play a role.

The following have proven useful:
shaking the batch, for example 1 minute to 6 hours,
shaking the batch in an ultrasound batch, for example 5 to 30 minutes,
allowing the batch to rest, preferably at room temperature,
spin-coating of the derivative solution,
dropwise addition of the derivative solution,
dip-coating in the derivative solution, or
air-brushing of the derivative solution.

Thereafter, optionally multiple washing steps with bidistilled water or DMA or with methanol, ethanol or 2-propanol are performed, for example while shaking the mixture or in an ultrasonic bath. In the end, the composite substrate material is dried over argon. The composite substrate material, however, remains bonded. Depending on the substrate material and the pretreatment thereof, the modification of the substrate surface is typically completed after 1 to 5 minutes of shaking, after subsequent thorough washing with bidistilled water or DMA and subsequent drying over argon.

The use of the inventive method is particularly significant for nano-technology purpose
when combined with mCP, for producing composite substrate materials with nanoscale patterns of surface structures or
for producing analyte-sensitive biochips in micro-fluidic sensor systems.

When comparing a calculated value D=0.8 nanometers for the thickness dimension of PDA cellulose chains based on computer molecule model methods to ellipsometrically determined thickness dimensions D=0.5 to 1 nanometer, confirmed by means of AFM, of PDA cellulose tosylate polymer chains (see formula pattern 1) on AU (111) substrate surfaces, a conclusion can be drawn that quasi mono-layers of the aminocellulose polymer chains are transmitted onto the substrate surface.

By means of computer-based calculations of the molecule model of polymer chain monolayers for EDA cellulose (see type a, i=2, formula pattern 1) D=1 nanometer and for TEPA cellulose (see type b, formula pattern 1) D=3 nanometer is obtained.

Advantageously, the modified composite substrate materials and the surfaces thereof have a defined topography with low RMS roughness values of typically 0.1 to 1.5 nanometers.

Even following short-term treatment of the substrate with a modifying solution, the surface structures via derivatives according to formula patterns 1 and 2 are firmly fixed on the substrate surface, as subsequent reactions with NH₂-reactive coupling reagents, treatments of the modified substrate samples with solvents or aqueous solutions with alternating electrolyte composition in ultrasonic baths as well as under kinetic measurement conditions with a mass-sensitive measurement of the modified substrate samples in micro-fluidic sensor systems have demonstrated.

In some cases, the composite substrate materials were treated, for example with a 1% aqueous glutaraldehyde (GDA) solution, for a short time of approximately 10 to 30 seconds and subsequently washed multiple times with bidistilled water, free of excess GDA.

The effect of partial cross-linking of the surface structure or of the aminocellulose polymer chains is also achieved with HN₂-reactive reagents other than GDA. Partial cross-linking is used, for example, in the special case when surface structures with a thickness of greater than 3 nanometer, that is molecular multi-layers, are required on the substrate surface.

Essential parameters used for the characterization of the composite substrate materials include the thickness measurements of the surface structures, the NH₂ group density or concentration per substrate sample surface, the water contact angle and the RMS roughness value.

The NH₂ groups of the surface structures that are laterally transmitted by means of aminocellulose polymer chains (see (X), types a to d, formula pattern 1) and/or NH₂-(organo)polysiloxane polymer chains (see (X)=a to c, formula pattern 2) onto the substrate surfaces, serve amongst others as NK₂ anchor groups for the covalent bio-functionalization process. The density or concentration of the NH₂ anchor groups per substrate sample surface is an important aspect for the application possibility of the inventive composite substrate materials. The water contact angle KW serves as a measure for the hydrophobicity or hydrophilicity balance of the surface structures.

In a further embodiment of the invention, the substrate surfaces are pretreated for approximately. 30 seconds to 2 minutes with oxygen or argon plasma.

In the subsequent inventive treatment with the modifying solution, the resulting composite substrate materials frequently have the lowest thickness dimensions and RMS roughness values.

Advantageously, the modified substrate surfaces can be stored after production without time limits
for completing the surface modification process, for example by mCP or by NH₂-reactive reagents or functionalization for the purpose of adjusting application-specific surface properties, such as the pH value, charge distribution, hydrophilicity or hydrophobicity balance, redox-active or light-absorbing properties and/or
for electrostatic or covalent coupling with function molecules, for example of functional biomolecules or proteins or cells or cell components.

In summary, the invention for the first time provides a simple method of a comprehensive structured design of substrate materials relevant for future technologies. The structural design is based on the use and modification of the aminocellulose lead structure P—CH₂—NH—(X)—NH₂ (P—CH₂-=cellulose-C6, see formula pattern 1) with the structure-forming and bio-compatible properties of the cellulose structure that can easily and with versatility be modified by spacer structures (X) on the AGU position C6 and ester groups S on C2/C3 as well as by variation of the substitution levels DSNH (X) NH₂ und DSS along the cellulose polymer chains;
of special NH₂-(organo)polysiloxanes (see formula pattern 2), particularly in combination with mCP;
diverse NH₂-reactive bifunctional reagents for further functionalization, particularly the bio-functionalization of substrate surfaces for biophysical and biomedical applications.

The invention according to the invention can be completed by including further suited NH₂ polymers, for example aminopolysaccharides other than aminocellulose according to formula I.

In the following, applications of the method according to the invention and the composite substrate materials produced in this way are described only by way of example, without limiting the invention.

### 3. Fields of Applications

### 3.1 Biophysical Field of Application

### 3.1.1 Surface Modification of Si Tips for Scanning Probe Methods

Modified Si tips are required, for example in the case of atomic, force microscopy (AFM) for force distance or force modulation measurements of functionalized substrate surfaces, for example biochip surfaces, or in the case of scanning probe lithography techniques for the lateral nano-structuring of substrate surfaces, for example biochips.

For the modification of Si tips, the procedure is as follows:

The Si tip that is attached to a cantilever is adhesively fixed on a gel pack with this cantilever such that the Si tip points into the area. The Si tip is then carefully cleaned or pretreated in a suitable manner and subsequently wetted with a modifying solution of a suitable derivative according to formula pattern 1 or 2. During this process, solutions and concentrations that are common for this method are used. After a wetting duration of approximately 30 minutes to 3 hours, the modifying solution is removed and the modified Si tip is rinsed 3 to 5 times with 30 to 50 ml solvent (for example bidistilled water, DMA or 2-propanol). Afterward, the cantilever fixed on the gel pack is dried over argon and subsequently used for AFM measurements in order to characterize the modification effect based on a suitable sample surface.

The modification effect becomes clearly visible if, for example in the atomic force microscopic non-contact mode, the modified Si tip is compared to the non-modified Si tip by means of AFM measurement of a calibration sample, on the surface of which spherical shapes on Si basis with dimensions of a few nanometers are located, with respect to the depicted topographic characteristics.

The special effect when measuring the calibration sample is that the respective Si tip located in the AFM device by means of the cantilever is depicted topographically. Accordingly, the non-modified Si tip is depicted in a typical spherical topography. This is not the case for the described modified Si tip. Here, the topographic (3D) image shows a split sphere tip, that is quasi a double tip.

This topography reflects the aminocellulose polymer chains located on the Si tip. The notion on the microscopic observation level is that the adhesively fixed polymer chains with an ideal chain length of approximately 100 nanometers so-to-speak protrude around the Si tip in a fringed manner that is topographically depicted during scanning of the calibration sample as an elongated artificial or split tip.

Particularly advantageous is the further functionalization of the Si tips modified according to the invention by means of the above-mentioned NH₂-reactive coupling with function molecules that are relevant for the respective application case of the scanning probe technology. Relevant for scanning probe technology are, for example, function molecules that bring about force distance or force modulation effects during the AFM measurement of modified substrate surfaces or enable a lateral structure transmission via function molecules onto substrate surfaces with scanning probe lithography techniques.

### 3.1.2 Surface Modification of PDMS Substrates

Due to their advantageous physical, chemical and biocompatible properties, polydimethyl siloxanes (PDMS) play a special role in micro- and nano-technology as soft and easily deformable polymers, for example as stamp for mCP, as biochip material specifically in microfluidic sensor systems or as implant materials, particularly also due to the silane-chemical modifiability of the PDMS treated with oxygen plasma. The important aspect is to modify the PDMS surface as application-specific as possible, for example analyte-sensitive or bio-functional. By treating the PDMS surfaces with oxygen plasma, OH groups develop (water contact angle less than 20 degrees). It is known that the OH groups are modified by means of silane compounds with the inventive method, for example, PDMS stamps are modified in the above-described manner for molecular imprinting, using interaction-specific structure areals, such as hydrophobic, electrostatically-oriented or complementary or bioactive structure areals. The variety of derivatives according to formula patterns 1 and 2 is available for all applications that are mentioned. For example, the PDMS surfaces treated with oxygen plasma are modified in the inventive manner through brief contact with the respective modifying solution. The result is a PDMS composite material with surface structures smaller than 1-2 nanometers, RMS roughness values of less than 0.2-0.5 nanometers, water contact angles from less than 50 to greater than 90 degrees and NH₂ group densities of 0.5-1.5 nMol per cm² of substrate surface.

### 3.1.3 Method According to the Invention by Means of MCP

Based on regularly micro- or nano-structures stamps made of polymer materials, surface structures are stamped in corresponding microscale or nanoscale patterns on the substrate surfaces by means of derivatives according to formula patterns 1 and 2. Suitable micro- and nano-stamps are preferably made of poly(dimethylsiloxane) (PDMS) in the known manner, for example Sylgard 184-Kit comprising Sylgard-184 A and Sylgard-184 B. Parallel lines with line widths of 200 nm to 4 mm and line distances of 200 nm to 200 mm can serve as stamping patterns, for example. It is also possible to micro- or nano-contact stamp made of materials other than PDMS.

In the case of the Si/SiO₂ substrate surfaces used by way of example, with mCP the process is as follows, starting with aminocellulose derivatives and NH₂-(organo)polysiloxane derivatives according to formula pattern 1 or 2: An amount of 5 to 10 ml of a 0.05 to 0.5% solution of a derivative of the aminocellulose lead structure, for example a PDA cellulose tosylate solution in DMA, is dropped onto the line pattern of a PDMS stamp (for example line distances: 200 nm to 50 mm). Then, press the stamp with the wetted side carefully onto filter paper for 1 to 5 seconds and afterward bring it immediately in contact with an Si/SiO₂ substrate surface, preferably for 2 to 15 minutes, while applying slight pressure. After this, remove the stamp from the substrate surface and shake the surface for 5 to 30 minutes in DMA while replacing the DNA phase several times. Then, the stamped substrate surface is dried over argon and the line pattern is characterized by depicting ellipsometry and AFM, for example by (incident light) microscopy (with polarization filter). During the microscopic analysis of the stamped substrate surfaces, the micro-scale line pattern of the surface structures becomes visible and line-shaped surface structures are illustrated and measured by depicting ellipsometry. The findings are composite substrate materials with surface structures of <1-3 nm (depending on the derivative used). These thickness dimensions of the surface structures determined by ellipsometry are confirmed with AFM. By means of AFM, line widths are discovered that agree with the target values of 200 nm to 4 m of the micro- or nano-stamps used.

The mCP method is used for the above-defined substrate surfaces also with modifying solutions of NH₂-(organo)polysiloxane derivatives P1 to P5 according to formula pattern 2.

For example, a line structure pattern 2 to 200 mm apart is stamped onto Si/SiO₂ substrate surfaces by means of mCP. For this, for example, 5 to 10 ml of a 0.03 to 0.1% solution of an NH₂-(organo)polysiloxane (for example type P2b) in 2-propanol is added dropwise on the PDMS stamp, then proceeding as with mCP with aminocellulose derivative. After removing the stamp from the substrate surface, the surface is shaken for 5 to 15 minutes in 2-propanol while replacing the 2-propanol phase several times. After this, the stamped substrate sample is dried over argon and the line pattern is characterized in the same manner as with mCP by means of aminocellulose derivative. By means of AFM, line-shaped surface structures with thickness dimensions of <1-2 nm and line widths corresponding to the target values of the stamp are found.

Both methods, that is the inventive method and variants of mCP, enable, in a synergistic manner, the optimization of substrate surfaces with property and/or interaction patterns, for example for bio-functionalization or bio-physical applications or for protein and cell adhesion and so forth, depending on the criteria of the individual application case.

In this process, derivatives according to formula patterns 1 and 2 were used. It is also possible to produce structured patterns that differ from line patterns on the substrate surfaces using corresponding micro- or nano-stamps. The variety of variants provided by the inventive method and mCP will be explained hereinafter with reference to examples.

### EXAMPLE 1

Depending on the application, a substrate surface is modified according to the invention by means of an aminocellulose derivative of the b type series forming Cu chelate (for example TETA cellulose derivative) and then stamped with a pattern of PDA cellulose tosylate (with redox chromogenic properties) by means of mCP. A redox-active protein, referred to as a Cu protein, for example, is immobilized on the NH₂ anchor groups of the PDA radical.

### EXAMPLE 2

Depending on the application, a substrate surface is modified according to the invention either by an aminocellulose derivative of the b type series, for example a DPTA cellulose derivative, for forming Cu chelates or adjusting a protein-relevant pH value, or by means of a redox-active aminocellulose derivative of the c or d type series and is then stamped with a pattern of an aminocellulose derivative of type a with spacer effect or from an NH₂-(organo)polysiloxane derivative P1 to P5 by means of mCP. The free NH₂ anchor-groups are biofunctionalized by an NH₂-reactive coupling reagent that is adjusted to the bio-function.

### EXAMPLE 3

Depending on the requirements of the application, a substrate surface is hydrophilized by means of SiOₓ polymer and subsequently a pattern from an aminocellulose derivative of the a or b type series or an NH₂-(organo)polysiloxane derivative P1 to P5 is stamped in by means of mCP.

### EXAMPLE 4

Depending on the requirements of the application, a substrate surface is modified according to the invention by means of an NH₂-(organo)polysiloxane derivative P1 to P5 and then a pattern is stamped from an aminocellulose derivative or a derivative mixture of the type series a to c by means of mCP in order to adjust biorelevant properties (such as pH value, charge distribution, water-contact angle) by a NH₂-reactive subsequent reaction and/or to immobilize (bio-)function molecules.

In a further mCP variant, a stamp surface is wetted with the derivative solution (as “stamping ink”) by means of an ink pad. For example, a PDMS ink pad (approximate dimensions 10×10 mm, thickness approximately 1 to 3 mm) is poured from “PDMS Sylgard 184” material, then soaked with the modifying solution for about 3 hours while stirring and then dried over argon for 1 to 2 minutes. The PDMS stamp is pressed onto the pretreated ink pad and is subsequently brought in contact with the substrate surface for about 2 minutes. The stamped substrate sample is then treated and characterized as described above.

3.1.4 Surface Structure Pattern with Gold Nano-Particles

Upon contact with commercially available gold colloid solutions, gold nano-particles can be adhesively fixed onto structure patterns that are stamped onto a substrate surface by means of mCP from derivatives according to formula pattern 1 or 2. On a substrate surface, for example, alternating structure patterns are produced, on the one hand for the adhesion of gold nano-particles and on the other hand for bio-functionalization. Such derivatives according to formula patterns 1 and 2 are used that correspond to the structural or functional requirements of the bio-function used. Gold nano-particles play an important role, for example on substrate surfaces, in conjunction with functional biomolecules or proteins in biochip development or bioelectronic function blocks.

When producing a substrate surface with a structured pattern made of adhesively fixed gold nano-particles and a bio-function in accordance with the invention, the following procedure could be followed, for example: A substrate surface is stamped with a derivative according to formula pattern 1 or 2. Then, the stamped substrate surface is treated with a commercial available gold colloid solution (gold nano-particles: 3 to 30 nm) and then modified according to the invention with a biomolecule-specific surface structure made of a derivative according to formula pattern 1 or 2. Afterward, biofunction molecules are covalently coupled to the NH₂ anchor groups of the modified substrate surface via NH₂-reactive bifunctional reagents.

Alternatively, depending on the bio-specific requirement a substrate surface is hydrophilized, for example, by means of SiOₓ polymer, then modified by means of a copper (Cu) chelate-forming aminocellulose derivative of type b according to formula pattern 1 and finally treated with a Cu ion solution. Then, the Cu ion-modified substrate surface is stamped, for example by means of mCP, with a surface structure made of a derivative according to formula pattern 1 or 2, for example in a line shape, and subsequently treated with a commercial available gold colloid solution (gold nano-particles: 3 to 30 nm). The substrate surface modified in this way is biofunctionalized either via a bio-specific NH₂-reactive coupling reagent or the substrate sample or the substrate sample is again treated with a modifying solution of a derivative according to formula pattern 1 or 2 for the purpose of adhesive coupling to the gold nano-particles and then a biofunction molecule, for example DNA sequences, is covalently immobilized in the conventional manner.

### 3.1.5 Biochips

SAW chips are made of quartz slices that are cut from a (quartz) mono-crystal. On the quartz surface, an SiO₂ polymer layer forms with a thickness dimension of approximately 5 mm as a signal-conducting layer. By means of silane-chemical methods according to the state of the art it is not possible to establish a reproducible coupling of biofunction molecules, for example DNA or RNA aptamers, on the SiO₂ polymer surface of the SAW chips.

The method according to the invention, in a particularly advantageous manner enables the surface modification of the SAW chip to a functional biochip directly on the signal-conducting SiO₂ polymer surface or on a gold (Au) layer provided thereon when the SAW chip is in a micro-fluidic sensor system. In the case of an Au-coated SAW chip, the Au surface is cleaned or pretreated in the conventional manner, for example by means of argon plasma, before using the inventive method.

Analyte-sensitive SAW chips are produced, for example, on the signal-conducting SiO₂ polymer layer in a micro-fluidic sensor system with the following steps:

STEP 1: For example, a 0.5% aqueous TETAT cellulose tosylate solution is conducted over the SAW chip (flow rate approximately 25 ml/min, flow duration approximately 9 minutes). The phase transformation observed as the usual measured variable, that is the increase in weight, of the SAW chip is complete after about 3 minutes. Afterward, bidistilled water is conducted through the micro-fluidic sensor system (flow rate approximately 25 ml/min, flow duration approximately 9 minutes) for the purpose of detaching TETAT cellulose tosylate that may be provided non-adhesively on the chip surface. During this step, hardly any signal change, that is hardly any detaching of mass, is observed. Step 1 is repeated under identical flow conditions with the identical TETAT cellulose tosylate solution. No mass or signal change of the SAW chip is observed—also not when conducting bidistilled water through (flow conditions as described above). This means, the modification of the SAW chip surface by means of TETAT cellulose tosylate solution is complete within a flow duration of 3 minutes.

STEP 2: The amino cellulose-modified SAW chip surface is functionalized by means of a conventional NH₂-reactive bifunctional reagent, for example glutaraldehyde (GDM). For this, a 25% aqueous GDA solution is conducted over the modified SAW chip surface (flow rate approximately 50 ml/min, flow duration approximately 5 minutes). Afterward, the bifunctional reagent not converted on the SAW chip surface is removed with bidistilled water at the identical flow rate and duration. The measured phase transformation and/or weight increase signal that the SAW chip surface was functionalized via GDA.

STEP 3: Starting with the GDA-functionalized SAW chip surface, an analyte (thrombin) sensitive SAW chip (SAW sensor chip) is produced by means of an anti-thrombin RNA aptamer. For this purpose, an anti-thrombin RNA aptamer solution in bidistilled water (1 mmolar) is conducted over the SAW chip surface (flow rate approximately 25 ml/min, flow duration approximately 9 minutes). The resulting phase transformation signals that the aptamer is present fixed on the SAW chip surface. When subsequently conducting bidistilled water through (flow rate approximately 25 ml/min, flow duration approximately 9 minutes), it is apparent that the aptamer has not detached yet. The SAW sensor chip is ready for use to measure thrombin as the analyte.

SENSOR TESTING OR MEASURING STEP: The test or measuring status of the micro-fluidic sensor system is adjusted with a SELEX buffer (1 mmolar, pH 8) to a flow rate of approximately 25 ml/min. The SAW sensor chip is thrombin-specific and free of non-specific protein bond, as test runs with thrombin or elastase and bovine serum albumin solutions in SELEX buffer show. The thrombin that is present on the sensor surface after the measuring cut, is detached with 0.1 molar NaOH solution. Subsequent repeat measurement of the thrombin solution in SELEX buffer confirms that the SAW sensor chip is regenerable and provides reproducible readings.

In the manner described above, it is also possible with the inventive method to modify sensor chip surfaces for measuring principles other than the SAW principle under the conditions of a micro-fluidic sensor system. The sensor chips can be made of different substrate materials, as defined in 2. With respect to the surface structures, at least the entire variety of derivatives according to formula patterns 1 and 2 is available. In addition, the structural variance can be expanded significantly further by additionally including further diamines, oligoamines or polyamines in the general derivatization process, as explained above.

### 3.2 Biomedical Field of Application

### 3.2.1 Structure Design of Substrate Surfaces for In Vitro Cell Cultures or Cell Adhesions

The adhesion or repulsion of proteins or living cells on boundary surfaces or substrate surfaces is an extremely complex process. For the purpose of analyzing correlations of cell adhesion, cell growth, cell differentiation, programmed cell death based on in vitro cell cultures on surfaces with the goal of medical implant development, using the principle of tissue engineering or biophysical use of cells (for example neurons or the like), influencing factors are searched based on modified substrate surfaces.

The structural heterogeneity of previously known modified substrate surfaces for in vitro cell cultures or cell adhesions is hardly suited for detecting these correlations. As a result, frequently poly- and oligo(ethylene glycols), dextrans and so forth are used as protein- and cell-resistant matrix structures for the production of lateral contrasts, for example of alternating structure areals with hydrophobic or hydrophilic properties on substrate surfaces.

To analyze cell adhesions, frequently also substrate surfaces with defined patterns of adhesion-requiring proteins, such as extracellular proteins, proteoglycans, collagens with repeating sequences Gly-Pro-Pro or fibronectin, fibrinogen, laminin and the like are used that interact with methyl-terminal surface areas. Alternatively, the coupling can also occur via oligopeptides with cell adhesion areas or covalently as well as non-specifically bonded antibodies.

The formation of covalent bonds as well as interactions via dehydration of hydrophobic surface areas between the substrate surface and proteins or cells are important aspects for the function of proteins and cells toward inactivity, displacement or reorganization while laterally shifting surface structures. The complexity increases with cell contacts because proteins and matter of the cell and culture medium interact with the substrate surface. The interactions are hydrogen bridge-driven or of an electrostatic, van der Waals (dispersive) as well as covalent nature.

In light of a completely new development in implant technology that for several years has been aimed at the use of cell culture techniques, methods for structure designs of cell-specific substrate surfaces are enormously gaining in importance for the development of biomaterial. In tissue engineering, new organs are formed based on functional cells on cell-specific carrier structures outside of the body to then implant them in a patient. Tissue engineering is associated with high expectations for the future of implant development. The goal is the production of surfaces that simulate the function of the extracellular matrix and enter specific reactions with the recipient tissue on receptor basis.

As a result of the inventive method, it is possible for the first time in combination with mCP to structurally model substrate material surfaces, particularly also such for implant purposes, on the basis of the derivatization of a natural polymer lead structure of the aminocellulose type with the general formula II with respect to questions related to the interaction between cells and substrate surfaces.

### 3.2.2 Surface Structure Design of Implant Materials

The conventional implant development process based on suitable metals/metal oxides and alloys, ceramics or polymers or textile materials also requires surface modification methods in order to increase the bio-functionality of the implant surface and control the processes on the boundary surfaces of implant/tissue or implant/blood as much as possible and optimize the ingrowth behavior of the implants. The important aspect is in particular to substantially prevent the two significant risks of immune response and blood coagulation cascade encountered with implants, for example stents (artificial vessel supports), artificial vessels, support implants and so forth.

Two significant paths are pursued:

1. The development of nano-structured bio-functional surfaces with improved blood or ingrowth behavior and

2. The coupling of biological signals on the implant surface to active control cell growth. This means that surface structures are required that are designed from a nano-technology point of view such that cells can grow on them particularly well or, depending on the application purpose, cannot grow there, for example as is the case with stents that are frequently associated with the risk of residual stenosis. With respect to the question is as to which surface structures have optimal bio-functional or bio-compatible properties, different notions exist according to the state of the art that also depend on the application conditions and the residence time of the implant. For example, hydrophobic surfaces with the Lotus effect play a role, or the irreversible passivation by protein, for example albumin, hydrophilic or negatively charged surfaces (minimization of protein adhesion) or surfaces with function molecules, for example antithrombotics such as heparin, fondaparinux, iduronic acid and the like. However, also the topography (roughness) of the implant surface influences bio-compatibility.

The inventive method of surface structure design offers all prerequisites to meet the above challenges of implant surface modification. This applies both to the inclusion of the various implant materials and to the production of the structural variety of the bio-functional surface properties. The method according to the invention can be used in principle with the following implant materials: Stainless steel, chrome or cobalt or nickel alloys, gold, platinum, titanium/titanium oxide, tantalum/tantalum oxide, ceramics, ceramic zirconium oxide, cellulose or bacterial cellulose in areal or tubular shape, poly(dimethyl siloxane) (PDMS), polymethyl methacrylate (PMMA, plexiglass), poly-N-isopropyl acrylamide (PNiPAM), poly(glycolide-co-lactide) (PGL), polymers with carboxyl or sulfo groups, such as polyhydroxyethyl methacrylate (PHEMA).

The method according to the invention is advantageously suited to produce structure patterns or structure areas on different substrate materials, particularly on the afore-mentioned implant materials, these patterns or areas having inherent hydrophobic or dispersive, hydrophilic, electrostatic or reactive properties as well as spacer effects or low roughness values. In addition, function molecules can be coupled to the surfaces of the composite implant materials via the above-mentioned NH₂-reactive bifunctional reagents in order to improve bio-compatibility. For example, the surface structures made of the derivatives according to formula patterns 1 and 2 are suited right from the start to fix the carboxyl- or sulfo-functionalized antithrombotics such as heparin, fondaparinux, iduronic acid, in place electrostatically.

At this point, the essential novel aspect should be emphasized, which is that the structural structuring of different substrate materials is performed particularly based on derivatives (according to formula pattern 1) of one and the same polymer structure, namely the cellulose structure, for example.

It is advantageous that during the derivatization of the lead structure according to formula I the functional properties on the AGU position C6—along the polymer chains—are modified, but that the basic common properties, such as the biocompatible, structure-forming, conformational, adhesive properties, are maintained.

In addition, all derivatives with the general formula I are laterally transmitted as conformationally uniform polymer chains onto different substrate material surface, while maintaining the above-mentioned basic properties, in the same manner by spontaneous adhesion and self-organization with the above-described mono-layer-like thickness dimension. Finally, the diversely modifiable structure feature or interaction areas of the (aminocellulose) polymer chains are laterally transmitted to the substrate material surfaces into micro-scale or nano-scale patterns by means of mCP. The possibilities of modifying the surfaces of substrate materials are considerably expanded by combining the lead structure derivatives with NH₂— (oligo)polysiloxanes and/or with the SiOₓ polymer modification.

In addition, the variety of the lead structure derivatives is by far not exhausted by the examples according to formula pattern 1, but instead, by including further diamines, oligoamines or polyamines in the general derivatization procedure, ultimately the possibilities of the structuring of substrate material or implant material surfaces can be expanded quite significantly.

From the above-described results, amino cellulose-modified composite substrate materials are known that remain free of non-specific protein adhesion. On the other hand, it is also known that the inventive composite substrate materials are excellently suited for bio-functionalization, for example for coupling with sensitive enzyme proteins, DNA or RNA aptamers, while maintaining the biological function thereof. The results and the above-mentioned advantageous surface properties of the composite substrate materials form the basis for a bio-compatible surface structure design of different implant materials or bio-materials.

### 3.2.3 Use of the Inventive Method of Active Ingredient Carriers

In diagnostics or therapy, great hopes are placed in drug delivery systems. These are, for example, surface-modified nano-particles made of SiO₂ or metal oxide nano-particles that serve as a vehicle for transporting the active ingredient to the site of action in the body. Advantageously, the inventive method can also be used to produce the necessary active ingredient carrier property by modifying the surfaces of the nano-particles.

The invention will be explained hereinafter with reference to specific illustrated embodiments.

### Substrate Samples on Silicon (Si) Basis

Rectangular or round Si substrate samples measuring 6×6 mm or D=10 mm were used as substrates of the Si type. For the test, Si substrate samples with a native silicon oxide or SiO₂ polymer layer and such with a thermally or pyrolytically produced SiO₂ or SiOₓ polymer layer were used, with varying thickness dimensions of <1-2 nm or 6 nm (thermally) up to 6 mm (in the case of SAW chips).

Rectangular and round microscopy cover slips measuring 10×10 mm or D=10 mm were used as the glass-type substrates. The cover slips can be pretreated before use with a detergent such as Extran solution and/or acetone in an ultrasonic bath for 10 minutes. Also pretreatment with a piranha solution or with concentrated sulfuric acid or nitric acid for 10 to 30 minutes and subsequent rinsing with bidistilled water is possible. Then, the samples were treated with oxygen or argon plasma for approximately 1 to 2 minutes.

Metal oxide substrate samples (Al oxide) Si chips (10×10 mm) were coated with aluminum oxide (Al oxide) by means of pulsed laser deposition (PLD) (thickness dimension=5 to 6 nm; KW: 70 to 80°; RMS roughness: 0.1 to 0.15 nm) and used without pretreatment.

### Au Substrate Samples

An Si wafer was sputtered or vapor-coated in step 1 with chrome (thickness dimension about 2-3 nm) and in step 3 in the conventional manner with a gold layer (thickness dimension about 100 nm). Then, the gold-coated Si wafer was cut into rectangular or round Au substrate samples measuring 6×6 mm or D=10 mm. Before use, the Au substrate samples were pretreated in different ways, for example with a 5% aqueous solution of Extran detergent in an ultrasonic bath for 1 to 5 minutes. Then they were washed with bidistilled water and absolute ethanol and dried over argon or treated with a piranha solution and thereafter, as described above, washed and dried or treated with oxygen or argon plasma in order to achieve the particularly low RMS roughness values or high quality during the inventive surface modification.

### Au(III) Substrate Samples

Au(III) sample surfaces (D=approx. 5 mm) were polished. Before each use, the Au(III) sample surfaces were treated with concentrated sulfuric acid for about 12 to 24 hours, then washed with bidistilled water and absolute ethanol and then, after drying in an argon flow, carefully annealed by means of a butane gas burner until they are yellow-hot for a duration of 5 to 10 minutes. The Au(III) sample surfaces were used immediately after cooling to room temperature or treated with a piranha solution prior to use.

### PDMS Substrate Samples

PDMS substrate samples were produced by means of the Sylgard 184-Kit (Dow Corning), comprising Sylgard-184 A and Sylgard-184 B, on Si chips. For this purpose, “A” and “B” were mixed at a ratio of 10:1 and diluted with hexane (1:1000). From each 5 ml batch of this mixture, the PDMS substrate samples were produced on round Si chips (D=10 mm, PDMS thickness dimension: 2 to 4 nm, ellipsometric) by means of spin coating (20 thousand rpm). For further use, the PDMS substrate samples were carefully treated with oxygen plasma (duration about 30 seconds and the sample was covered with a metal screen). After the treatment with oxygen plasma, the PDMS layer thickness was 1 to 2 nm. The PDMS substrate samples were used immediately for the inventive surface modification.

Treatment with hydrophilic SIOₓ polymer

A commercial silicoating process from the adhesive and dental technology industry was used in order to briefly hydrophilize heat-resistant substrate materials by forming an ultrathin SiOₓ polymer film. For this purpose, the substrate material surface was exposed for an extremely short period to the flame of a lighter-like device with a combustible “pyrosil” gas mixture with a silicon-organic compound. The resulting SiO₂/silicate mixture became a glass-like “SiOₓ polymer” in the form of an ultrathin and transparent film a short time later (thickness dimension <1 to 2 nm). The method can be used for all substrate materials with short stability (<1 second).

### Surface-Modified Substrates (Composite Substrate Materials)

General procedure guideline: For composite substrate materials with particularly low RMS roughness levels or the highest surface quality, the substrate surfaces were pretreated with oxygen plasma.

The surface modification or composite substrate material was produced by means of a modifying solution with which the substrate samples were brought in contact in various ways and for various durations. The modifying solution was either a 0.05 to 0.5% solution of an aminocellulose derivative according to the general formula I or formula pattern 1 in bidistilled water or dimethylacetamide (DMA) or it was a 0.3 to 0.1% solution of an NH₂-(organo)polysiloxane derivative P1 to P5 according to formula pattern 2 in methanol, ethanol or 2-propanol. The modifying solutions were filtered before use, preferably by means of a centrifugal filter tube (pore size approximately 0.2 to 0.45 mm). Depending on the application purpose, substrate material and pretreatment, different procedure variants were employed for the surface modifications, for example
shaking (1 minute to 6 hours)
shaking in an ultrasonic bath (5 to 30 minutes)
resting (1 to 12 hours)
spin-coating (1 to 20 thousand revolutions per minutes)
application in drops and residence time of 5 to 10 minutes
dip-coating (5 to 60 seconds)
air-brushing and residence time of 5 to 10 minutes
micro- and nano-contact printing (mCP).

In the case of the mCP, the modifying solution was brought in contact with the substrate surface by means of a micro- or nano-structured stamp made of polymer, preferably PDMS. The PDMS stamps were produced in the conventional manner from commercial “PDMS Sylgard 184”, for example depending on the application purpose with micro- or nano-structured line patterns or line distances. The modifying solution was applied as stamping ink on the stamp surface in various ways.

The surfaces of substrate samples or composite substrate materials modified either across the entire area or in patterns were washed multiple times and thoroughly with the respective solvent while shaking, for example in an ultrasonic bath, free of derivative fixed non-adhesively to the substrate surface and then dried over argon.

Depending on the type and pretreatment of the substrate samples and the specification of the required modification characteristics, for example thickness dimension of the surface structure, NH₂ group concentration/area, RMS roughness and the like, the modification procedure was complete in general after 1 to 5 minutes of shaking with subsequent washing with a solvent and drying in an argon flow.

The modified substrate samples were used directly after they were produced or after a holding period, for example after storage for an unlimited amount of time, for example
for further (for example NH₂-reactive) functionalization processes with hydrophobic, hydrophilic, charged, redox-active structures or pH or light absorption properties and/or
for the adhesive or covalent fixation of function molecules, for example bio-function molecules such as proteins, DNA or RNA or protein aptamers, cells or cell components or active ingredients.

### EXAMPLE 1

### Si Composite Material by Means of Aminocellulose Tosylate

In a 0.05% aqueous solution of an aminocellulose tosylate (type b, formula pattern 1), for example at room temperature, Si substrate samples
were shaken for 5 minutes or
then treated in an ultrasonic bath for 5 minutes or allowed to rest for 3 hours.

Then, the modified Si substrate samples were washed 3 to 4 times with 0.5 to 1 cm³ of bidistilled water while shaking, for example 3 times for 1 minute in an ultrasonic bath, and then tried in an argon flow.

Surface structure characteristics, for example thickness dimension (ellipsometric)<1-3 nm; KW: 60-80°; RMS roughness: 0.8-2 n; NH₂ group concentration: 0.2-1.3 nMol/cm².

### EXAMPLE 2

### Si Composite Material by Means of Aminocellulose Carbanilate

At room temperature, in a 0.1% solution of an aminocellulose carbanilate (type a, formula pattern 1) in DMA, Si substrate samples were
shaken for 1 minutes or
treated for 5 minutes in an ultrasonic bath or allowed to rest for 1 hour.

Then, the modified Si substrate samples were shaken 3 to 4 times with 0.5 to 1 cm³ of DMA for about 5 minutes or washed 2 times in an ultrasonic bath, and then tried in an argon flow.

Surface structure characteristics, for example thickness dimension (ellipsometric)<1-2 nm; KW: 55-70°; RMS roughness: 0.2-0.5 nm; NH₂ group concentration: 0.2-1.3 nMol/cm².

### EXAMPLE 3

### Si Composite Material by Means of EDA Cellulose by Spin-Coating

An amount of 1 or 2 ml of a 0.5% EDA cellulose carbanilate solution (type a, i-2) in DMA was added dropwise at room temperature onto Si substrate samples (D=10 mm) by means of spin coating (at 20 thousand rpm) (rotation duration 3-5 minutes). Then, the modified Si substrate samples were washed 2 times in an ultrasonic bath (duration approximately 10 minutes) with about 1 cm³ DMA each and then dried over argon.

Surface structure characteristics, for example thickness dimension (ellipsometric)<1 to 2 nm; water-contact angle: 60 to 75°; RMS roughness: 1 to 2 nm; NH₂ group concentration: 0.2 to 1 nMol/Cm2.

### EXAMPLE 4

### Si Composite Material by Means of NH₂-(organo)polysiloxane Derivative

At room temperature, in a 0.05 to 0.09% solution of an NH₂-(organo)polysiloxane derivative (P1 to P5, formula pattern 2), for example in ethanol or 2-propanol, Si substrate samples were
shaken for 1 to 5 minutes or
treated for 15 minutes in an ultrasonic bath or
allowed to rest for 6 hours.

Then, the modified Si substrate samples were shaken 3 to 4 times with 300 to 500 ml ethanol or 2-propanol, respectively, or washed 2 times in an ultrasonic bath (duration about 5 to 15 minutes) and then dried over argon. Particularly also mixtures of the NH₂-(organo)polysiloxanes according to formula pattern 2, for example P3a and P5, P3a and P3c, P2a and P5, in ethanol or 2-propanol were used.

When spin-coating was used, 1 to 2 ml of the respective NH₂-(organo)polysiloxane solution was added dropwise (rotation duration about 3 to 5 minutes) was added dropwise on the Si substrate samples (D=10 mm) at about 20 thousand rpm and then treated further as described above.

The surface structure characteristics were variable as a function of the NH₂-(organo)polysiloxane derivative with the concentration of the derivative solution and the conditions of the different procedures.

Surface structure characteristics, thickness dimension (ellipsometric)<1 to 3.5 nm; water-contact angle: 45 to 70°; RMS roughness: 0.5 to 1.7 nm (maximizable) and NH₂ group concentration: 0.1 to 2 nMol/cm².

### EXAMPLE 5

### Redox-Active Si Composite Material by Means of PDA Cellulose Tosylate

Si substrate samples were treated with SiOₓ polymer and then, at room temperature in a 0.1% solution of a PDA cellulose tosylate (type c, 1, formula pattern 1) in DA, for example at room temperature,
shaken for 30 minutes or
treated for 15 minutes in an ultrasonic bath or
allowed to rest for 3 hours.

Then, the modified Si substrate samples were washed 3 to 4 times with 0.5 to 1 cm³ DNA by shaking and then dried over argon.

Surface structure characteristics, thickness dimension (ellipsometric)<1 to 1.5 nm; water-contact angle: 70 to 80°; RMS roughness: 1 to 1.5 nm; NH₂ group concentration: 0.4 to 1 nMol/cm².

### EXAMPLE 6

### Glass Composite Material by Means of TETAT Cellulose Tosylate

(a) Cover slip substrate samples, pretreated as described above, were shaken in a 0.5% aqueous solution of a TETAT cellulose tosylate at room temperature for 30 minutes, then washed 3 to 4 times with 0.5 to 1 cm³ bidistilled water by shaking or 2 times in an ultrasonic bath and subsequently dried over argon.

Surface structure characteristics: thickness dimension <3 nm; water-contact angle KW: 60 to 75°, RMS roughness: <1 nm; NH₂ group concentration: 2 to 4 nMol/cm².

(b) Cover slip substrate samples were pretreated with SiOₓ polymer and shaken in a 0.5% aqueous solution of a TETAT cellulose tosylate at room temperature for 1 minute, then washed 3 to 4 times with 0.5 to 1 cm³ bidistilled water by shaking and subsequently dried-over argon.

Surface structure characteristics: thickness dimension <3 nm; water contact angle KW: 60 to 75°, RMS roughness: <1.5 to 2.5 nm; NH₂ group concentration: 4.8 to 5.5 nMol/cm².

### EXAMPLE 7

### Al Oxide Composite Material with Aminocellulose Derivative

In a 0.05 to 5% solution of an aminocellulose derivative (for example type b, formula pattern 1), for example at room temperature, Al oxide substrate samples were
shaken for 5 minutes or
allowed to rest for 1 to 2 hours.

Then, the modified Al oxide substrate samples were washed 3 to 4 times with 0.5 to 1 cm³ of the solvent used (DMA or bidistilled water) by shaking and then dried over argon.

Surface structure characteristics, thickness dimension (ellipsometric)<1.5 to 3 nm; water-contact angle: 65-802; RMS roughness: 0.5 to 1 nm; NH₂ group concentration: 0.5 to 1 nMol/cm² (for example modified by means of EDA cellulose tosylate). Or, thickness dimension (ellipsometric)<1 to 2 nm; water-contact angle KW: 60 to 75°, RMS roughness: <0.4 to 1 nm; NH₂ group concentration: 0.3 to 0.5 nMol/cm² (modified by means of EDA cellulose carbanilate).

### EXAMPLE 8

### Al Oxide Composite Material by Means of NH₂-(organo)polysiloxane Derivative

At room temperature, in a 0.04 to 0.1% solution of an NH₂-(organo)polysiloxane derivative (for example, P4b or P5b, formula pattern 2), for example in ethanol or 2-propanol, Al oxide substrate samples were
shaken for 5 minutes or
allowed to rest for 3 hours or
treated for 30 minutes in an ultrasonic bath.

Then, the modified Al oxide substrate samples were washed 3 to 4 times with 0.5 to 1 cm³ 2-propnaol by shaking and then dried over argon.

Surface structure characteristics, thickness dimension (ellipsometric)<1 to 3 nm; KW: 65-80°; RMS roughness: 0.24 to 0.5 nm; NH₂ group concentration: 0.5 to 1.2 nMol/cm².

### EXAMPLE 9

### Au Composite Material Via Aminocellulose Carbanilate

In a 0.05 to 0.1% solution of an aminocellulose carbanilate (type a or b, formula pattern 1) in DMA at room temperature, Au substrate samples were
shaken for 15 minutes or
treated for 15 minutes in an ultrasonic bath or
allowed to rest for 3 hours.

Then, the modified Au substrate samples were washed 3 to 4 times with 0.5 to 1 cm³ DNA by shaking and then dried over argon.

Surface structure characteristics, for example thickness dimension (ellipsometric)<0.5 to 1 nm; water-contact angle: 65 to 702; RMS roughness: 0.3 to 0.5 nm; NH₂ group concentration: 0.2 to 1.3 nMol/cm².

### EXAMPLE 10

### PDMS Composite Material Via Aminocellulose Derivative

PDMS substrate samples were treated with oxygen plasma and then, in a 0.05 to 0.1% solution of an aminocellulose derivative (type a or b, formula pattern 1) at room temperature,
shaken for 10 minutes or allowed to rest for 3 hours.

Then, the modified PDMS substrate samples were washed 3 to 4 times with 0.5 to 1 cm³ of the solvent used (DMA or bidistilled water) by shaking and then dried over argon.

Surface structure characteristics, thickness dimension (ellipsometric)<2 to 3 nm; KW: 65 to 80°; RMS roughness: <0.7 nm; NH₂ group concentration: 0.8 to 1.2 nMol/cm² (modified for example via EDA cellulose tosylate, type a, i=2), or for example thickness dimension (ellipsometric)<1 to 2 nm; RMS roughness: 0.3 to 0.6 nm; NH₂ group concentration: 0.5 to 1 nMol/cm² (modified for example via EDA cellulose carbanilate).

### EXAMPLE 11

### Si Composite Material by Means of mCP

(a) Si substrate samples were stamped with a PDMS stamp with TETAT cellulose tosylate structure patterns in periodically varying line distances: 2 mm, 1 mm, 500 nm and 200 nm and varying line widths: 2 mm, 1 mm, 500 nm and 200 nm. For this purpose, a 0.05 to 0.5% aqueous solution of a TETAT cellulose tosylate was added dropwise on the PDMS stamp. Then, the stamp was pressed carefully with the wetted side onto filter paper for 1 to 5 seconds and afterward brought immediately in contact with the Si substrate sample surface, preferably for 2 to 15 minutes, while applying slight pressure.

Then, the stamp was removed from the Si surface, the stamped Si surface was shaken for 15 to 30 minutes in bidistilled water while replacing the aqueous phase and subsequently dried over argon.

Surface structure characteristics: (line) thickness dimension (ellipsometric)<1-2 nm. During the AFM measurement, the periodic line pattern with the varying distances and line widths was verified. For the line widths approximate desired values were measured and (line) thickness dimensions of <1 to 3 nm were found.

(b) In another embodiment variant, starting from the same PDMS stamp, the Si substrate sample and a 0.05 to 0.5% aqueous solution of a TETAT cellulose tosylate, a stamp procedure variant was employed. For this, a PDMS ink pad (dimension about 1×1 cm, thickness about 3 mm) was cast from the “PDMS-Sylgard 184” material and soaked with the TETAT cellulose tosylate solution for about 3 hours while stirring. The PDMS stamp was pressed onto the pretreated ink pad and subsequently brought in contact with the Si substrate sample surface for about 5 minutes. The stamped substrate sample was then treated and characterized as described in (a). The results of the stamp procedure as described in (a) were confirmed.

### EXAMPLE 12

### Surface Modification of SAW (Sensor) Chips in Micro-Fluidic Sensor System

The modification of SAW chips starts with different SAW chip surfaces, for example (a) an SiO₂ polymer surface as a signal-conducting surface or (b) an Au surface on SiO₂ polymer as a signal-conducting surface.

Before inserting the SAW chip (b) in the micro-fluidic sensor system, the Au surface is pretreated in the manners described above.

STEP 1: For example, a 0.5% solution of a TETAT cellulose tosylate in bidistilled water was conducted over the SAW chip (flow rate approximately 25 ml/min, flow duration approximately 9 minutes). The signal of the phase transformation, that is the increase in weight, of the SAW chip was constant after about 3 minutes. Afterward, bidistilled water was conducted through the micro-fluidic sensor system (flow rate approximately 25 ml/min, flow duration approximately 9 minutes) for the purpose of detaching TETAT cellulose tosylate that may be provided non-adhesively on the chip surface. During this process, hardly any signal change, that is hardly any detachment of mass, was observed. Step 1 was repeated with the 0.5% TETAT cellulose tosylate solution under identical flow conditions. No mass or signal change of the SAW chip was observed—also not when conducting bidistilled water through (flow conditions as described above). The modification of the Au surface or SiO₂ polymer surface of the SAW chip by means of TETAT cellulose tosylate was therefore completed within a flow duration of 3 minutes.

STEP 2: The amino SAW chip surface was functionalized by means of a NH₂-reactive bifunctional reagent, for example glutaraldehyde (GDM). For example, a 25% aqueous glutaraldehyde solution was conducted over the modified SAW chip surface (flow rate approximately 50 ml/min, duration approximately 5 minutes). Afterward, the bifunctional reagent not converted on the SAW chip surface was removed with bidistilled water at the identical flow rate and duration. The measured phase transformation and/or weight increase signaled that the SAW chip surface was functionalized via GDA.

STEP 3: Starting with the modified SAW chip surface, an analyte (thrombin) sensitive SAW chip was produced by means of an anti-thrombin RNA aptamer. For this purpose, an anti-thrombin RNA aptamer solution in bidistilled water (1 mmolar) was conducted over the SAW chip surface (flow rate approximately 25 ml/min, flow duration approximately 9 minutes). The resulting phase transformation signals that the aptamer is present fixed on the SAW chip surface. When subsequently conducting bidistilled water through (flow rate approximately 25 ml/min, flow duration approximately 9 minutes), it is apparent that the aptamer has not detached. This means that the SAW sensor chip was suited to measure thrombin as the analyte.

Sensor testing or measuring step: The test or measuring status of the micro-fluidic sensor system was adjusted with a SELEX buffer (1 mmolar, pH 8) to a flow rate of approximately 25 ml/min. The SAW sensor chip was thrombin-specific and free of non-specific protein bond, as test runs with thrombin or elastase and bovine serum albumin solutions in SELEX buffer showed. The thrombin that was present on the sensor surface after the measuring cut, was detached with 0.1 molar NaOH solution. Subsequent repeat measurement of the thrombin solution in SELEX buffer confirmed that the SAW sensor chip is regenerable and provides reproducible readings.

The modification of SAW (sensor) chips was also successful via NH₂-(organo)polysiloxane derivatives and with the variation of the NH₂-reactive reagent or the bio-function molecule type.

### EXAMPLE 13

### Functionalization by Means of NH₂-Reactive Bifunctional Reagents

The functionalization serves the modification of the above-mentioned surface properties, particularly the bio-functionalization.

General procedure: For functionalization purposes, the substrate composite material was shaken in a typically saturated solution of an NH₂-reactive bifunctional reagent for 5 to 60 minutes or allowed to rest. Then, the functionalized substrate sample was washed multiple times while shaking, dried over argon and then used for the application purpose, particularly bio-functionalization.

To vary the water-contact angle, the pH or charge distribution properties and/or for bio-functionalization, preferably the following bifunctional reagents were used:

L-ascorbic acid, 1,3-benzene-disulfonylchloride, 1,4-benzene disulfonylchloride, phthaldialdehyde, isophthaldialdehyde, 1,4-diacetylbenzene, 1,3-diacetylbenzene, glutaraldehyde, benzoquinone, 1,3-benzene-dicarboxylic acid dichloride, 1,4-benzenedicarboxylic acid dichloride, cyanurchloride.

1. A method of modifying a substrate comprising the following steps:
by means of a modifying solution, the substrate is brought in contact with at least one derivative of an amino cellulose and/or
with at least one derivative of an NH₂-(organo)poly-siloxane,
wherein a composite substrate material forms from the substrate and aminocellulose derivative and/or substrate and NH₂-(organo)polysiloxane.

2. The method according to claim 1 wherein the modified substrate is washed at least once with a solvent of the respectively employed aminocellulose or NH₂-(organo)polysiloxane derivative.

3. The method according to claim 1 wherein the composite substrate material is formed by means of NH₂-reactive and/or OH-reactive reagents.

4. The method according to claim 1, wherein the composite substrate material is functionalized or chemically activated with a solution of L-ascorbic acid, 1,3-benzene-disulfonylchloride, 1,4-benzene disulfonylchloride, phthaldialdehyde, isophthaldialdehyde, 1,4-diacetylbenzene, 1,3-diacetylbenzene, glutaraldehyde, benzoquinone, 1,3-benzene-dicarboxylic acid dichloride, 1,4-benzenedicarboxylic acid dichloride or cyanurchloride.

5. The method according to claim 1, wherein a surface modification of the composite substrate material is performed by means of bifunctional reagents, preferably NH₂-reactive bifunctional reagents and by the coupling of function molecules, preferably bio-function molecules.

6. The method according to claim 1 wherein the substrate is pretreated with an SiOₓ polymer for forming OHT groups before being brought in contact with the modifying solution.

7. The method according to the preceding claim, further comprising the step of
selecting proteins, nucleic acids, DNA or RNA or protein aptamers, cells or cell components, antithrombotics or active ingredient as the (bio-)function molecules.

8. The method according to claim 1 wherein a substrate comprising glass, metal, stainless steel, metal oxide, ceramics, silicon, polysaccharide, polymer or protein is selected.

9. The method according to claim 8 wherein the substrate is oxidized prior to modification by the aminocellulose derivative and/or NH₂-(organo)polysiloxanes.

10. The method according to claim 1 wherein a polysiloxane, is selected as the substrate.

11. The method according to claim 1, using a 0.05 to 0.5% modifying solution of an aminocellulose derivative.

12. The method according to claim 1 wherein bidistilled water or dimethylacetamide (DNA) is used as the solvent of the modifying solution.

13. The method according to claim 1, using a 0.03 to 1% NH₂-(organo)polysiloxane 0.03 to 0.1% modifying solution.

14. The method according to claim 13 wherein methanol, ethanol or 2-propanol are used as the solvent for the NH₂-(organo)polysiloxane.

15. The method according to claim 1, wherein the substrate is brought in contact with a 0.05 to 0.09% solution of a NH₂-(organo)polysiloxane with the general formula P1b, P2b, P3b, P4b or P5b, dissolved in 2-propanol.

16. The method according to claim 1, wherein the substrate is first brought in contact with a NH₂-(organo)poly-siloxane solution and then with an aminocellulose derivative solution.

17. The method according to claim 16, characterized by a NH₂-(organo)polysiloxane with the general formula P1b, P2b, P3b, P4b or P5b of formula pattern 2 and an aminocellulose derivative according to types a to c of formula pattern 1.

18. The method according to any one claim 1, wherein after the modification with a NH₂-(organo)polysiloxane derivative a hydrochloric acid, sulfuric acid or acetic acid treatment is performed.

19. The method according to claim 1, wherein the substrate is shaken with the modifying solution for 1 minute to 6 hours.

20. The method according to claim 1, wherein the substrate is brought in contact with the modifying solution by means of an ultrasonic bath, spin-coating, dip-coating, air-brushing, micro-contact printing (mCP), or shaking.

21. The composite substrate material, produced according to claim 1 wherein the aminocellulose derivative and/or NH₂-(organo)polysiloxane is provided on the substrate in the form of mono-layers.

22. A composite substrate material according to the preceding claim, characterized by a thickness dimension of <5 nanometers.

23. The composite substrate material according to claim 21 wherein the aminocellulose derivative and/or NH₂-(organo)polysiloxane is firmly adhesively fixed in place.

24. The composite substrate material according to claim 21 wherein the RMS roughness of the composite substrate material is <0.2 to 2 nanometers.

25. The use of a composite substrate material according to claim 1 for the production of implants, chips, nano-particles or scanning probe tips.
